(19) United States
(12) Patent Application Publication
(10) Pub. No.: US 2003/0195774 A1
(43) Pub. Date: Oct. 16, 2003

(54) Medical practice management system

(76) Inventor: Fred E. Abbo, La Jolla, CA (US)

Correspondence Address: BAKER BOTTS L.L.P., 2001 ROSS AVENUE, SUITE 600, DALLAS, TX, 75201-2980, US

(21) Appl. No.: 10/447,512

(22) Filed: May 28, 2003

Related U.S. Application Data
(63) Continuation of application No. 09/385,346, filed on Aug. 30, 1999.

(51) Int. Cl. G06F 17/60

(52) U.S. Cl. 705/3

(57) ABSTRACT

A medical practice management system is provided. The system includes an application comprising one or more modules directed to managing various aspects of a medical practice. The modules manage patient information and other information in order to enhance the efficiency and quality of the operation of a medical office. The modules may operate independently or in conjunction with each other.

### RELATED APPLICATION

This application is a continuation of U.S. application Ser. No. 09/385,346 filed Aug. 30, 1999, by Fred E. Abbo, entitled “Medical Practice Management System.”

### TECHNICAL FIELD OF THE INVENTION

The invention generally relates to the field of medical practice management and, more specifically, to a system for managing a medical practice and the patients served by the medical practice.

### BACKGROUND OF THE INVENTION

The field of medicine has become increasingly more complex. Doctors are faced with managing increasing amounts of information. This information extends beyond the typical types of information historically maintained by practitioners. Also, increasing numbers of patients are being cared for and managed by relatively fewer physicians. Further, increasing complexities in regulation and in medical insurance have added to the amount and complexity of patient information that must be maintained and managed by the physician.

Computer program applications are used to assist physicians with respect to certain discrete areas of their medical practice. Information given to a patient (e.g., at the conclusion of an office visit) is typically provided in written form in the handwriting of the physician. To the extent any printed material is provided it is typically a mix of pieces of information generated from different sources, each piece being directed to a discrete aspect of the patient's medical status.

### SUMMARY OF THE INVENTION

The present invention is directed to a comprehensive, integrated computer program application and system to manage multiple aspects of a medical practice. The invention is also directed to a medical practice management system capable of summarizing clinical events associated with a patient's medical status and interaction with a medical office, and outputting those events into a predetermined, user-friendly format, which may be printed for delivery to the patient. The information delivered to the patient may include such things as a summary of the patient's clinical events and a summary of a current medical office visit. Among other things, the present invention addresses the shortcomings of the typical way in which information is provided to the patient concerning that patient's medical status.

In one embodiment, the present invention includes a medical practice management system. The system may include an application, which may be a computer software program executable on a processor or multiple processors. The application may include one or more modules for managing information corresponding to one or more aspects of a medical practice. The system may also include an input device and an output device, or multiples of these devices.

According to one feature, the application includes a patient information module. The patient information module includes a medical record function. The medical record function includes a medical events function adapted to receive, as input, one or more medical events and provide, as output to a medical events field, a listing of the one or more medical events in an order according to at least one predetermined criterium.

According to another feature, the medical record function also includes a past medical history function adapted to receive, into a past medical history field, one or more types of information about a patient's medical history. The information may be distributed to one or more subfields of the past medical history field. The one or more subfields may correspond to the one of more types of information.

According to other features, the patient information module may also include other functions. These functions may include a diagnosis function, a medication prescription function, a recommended diet function, a recommended activity function, a follow-up reminder function, a laboratory test results function, a consultant specialist selection function, a patient advisory function, and a fee charge function.

According to still other features, the application may include other modules. These other modules may include a completed visit module, a laboratory reports module, a prescription module, a health maintenance module, a log module, an electronic mail module, an address module, a patient record module, a literature module, an administrative module, a consultants module, a scheduling module, a hypotheses module, a time keeper module, and a research module.

In another embodiment, a medical practice management system includes at least one processor and at least one application executable by the at least one processor. The application includes at least one module. The at least one module includes a patient information module. The patient information module includes a medical record function. The medical record function includes a medical events function adapted to receive, as input, one or more medical events and provide, as output to a medical events, field a listing of the one or more medical events.

In another embodiment, a medical practice management system includes at least one processor and at least one application executable by the at least one processor. The application includes a patient information module, a laboratory reports module, a prescription module, and a completed visit module.

In another embodiment, the invention provides a medical practice management network. The network includes a first medical practice management system and a second medical practice management system.

In another embodiment, the invention provides a software program application for use in a medical practice management system. The application includes a patient information module. The patient information module includes a medical record function. The medical record function includes a medical events function adapted to receive, as input, one or more medical events and provide, as output to a medical events field, a listing of the one or more medical events.

### BRIEF DESCRIPTION OF THE DRAWINGS

For a more complete understanding of the present invention, and for further features and advantages, reference is now made to the following description taken in conjunction with the accompanying drawings, where like reference numerals represent like parts, in which:

FIG. 1 is a medical practice management system according to an embodiment of the present invention;

FIG. 2 is a medical practice management network according to an embodiment of the present invention; and

FIG. 3 is an application and various associated modules, which may be incorporated into the system and network of FIGS. 1 and 2.

### DETAILED DESCRIPTION OF THE INVENTION

The present invention is directed to a comprehensive, medical practice management system. The system includes an integrated computer program application to assist a physician in maintaining and managing the information necessary to efficiently operate a medical practice and manage patients' medical information. This information primarily consists of patient information, but can also include information generated by the doctor or imported from an outside source that is not directed to a particular patient.

The application may comprise many different modules that may each function independently or may operate in conjunction with one or more other modules. These modules may include a registration module, a sign-in module, a patient information module, a completed visit module, a laboratory reports module, a prescription module, a health maintenance module, a log module, an electronic mail module, an address module, a patient record module, a literature module, an administrative module, a consultants module, a scheduling module, a hypotheses module, a time keeper module, a research module, and other modules. Each of these modules is provided to automate particular aspects of the physician's medical practice. The application, therefore, increases the physician's efficiency and enhances the quality of care provided to the patients. The application also increases the reliability, quantity and quality of documentation regarding a patient's health history.

In managing a patient's medical problem, a physician must perform several activities including: (1) obtaining a medical history of the problem; (2) examining the patient; and (3) making a decision regarding diagnosis, treatment, and follow-up. These professional tasks utilize the physician's knowledge base derived from both training and experience.

In general, the medical management process deals primarily with information. This can include information obtained from the patient, information about the patient obtained from testing and other indirect methods, knowledge possessed by the physician, diagnosis and treatment information, information for distribution to the patient, and stored information. The present invention is designed to utilize the unique advantages of the computer in order to automate the management, storage, manipulation and delivery of this information. The invention provides this capability without intruding on areas involving the physician's unique skills such as obtaining medical histories, conducting physical examinations, and making medical decisions.

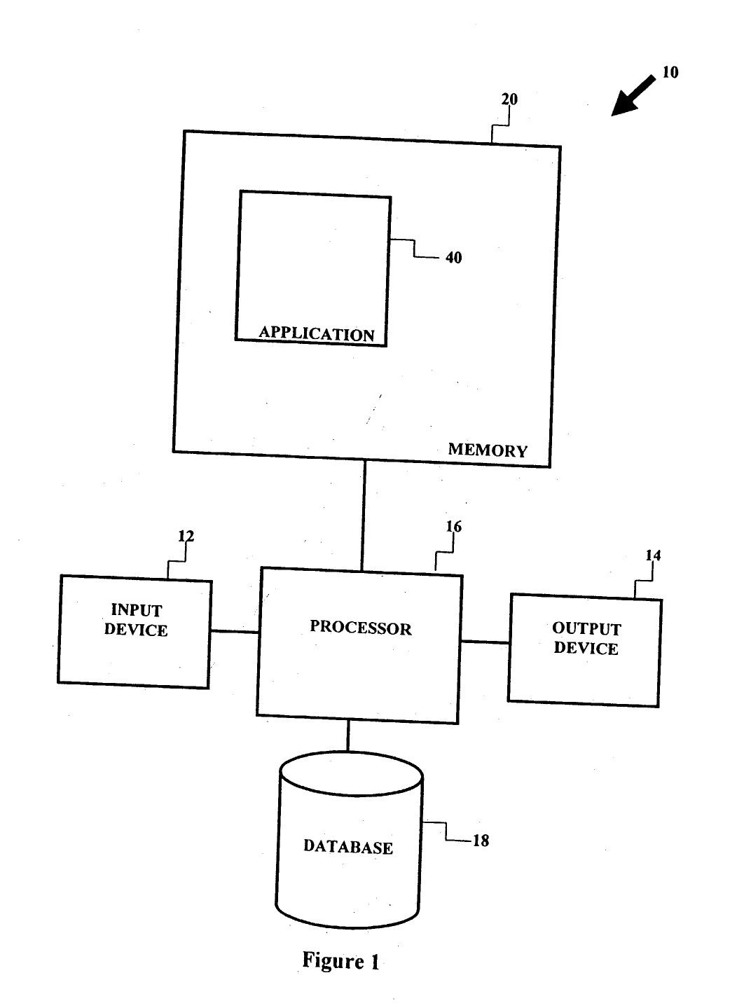

FIG. 1 depicts a medical practice management system 10 in accordance with an embodiment of the present invention. It will be understood that system 10 may be otherwise configured within the scope of the present invention. For example, system 10 may operate as a stand alone system or may operate as a client-server networked system. Also, system 10 may operate in a network environment such as a LAN, WAN, intranet, extranet, or Internet.

System 10 may comprise an input device 12, an output device 14, a processor 16, a database 18, and memory 20. Input device 12 may include a pointing device such as a mouse, a track pad, a keyboard, and the like. Also, input device 12 may include a combination of these devices. Output device 14 may include a monitor, a printer, and the like, or any combination of these devices.

Memory 20 includes computer software that may be executed by processor 16. The computer software may generally be identified by modules in memory 20. It will be understood that the computer software may be otherwise combined and/or divided for processing within the scope of the present invention. Accordingly, labels of the modules for illustrative purposes and may be varied and still remain within the scope of the present invention. Also, while only one processor is depicted, it should be understood that the system 10 may comprise multiple processors. Further, any appropriate software platform may be utilized including functional or object-oriented programming.

The computer software may be loaded into memory 20 from disk storage (not explicitly shown). Disk storage may include a variety of types of storage media. For example, disk storage may include floppy disk drives, hard disk drives, CD-ROM drives, or magnetic tape drives.

Database 18 includes computer records that may be generally identified by tables. It will be understood that the computer records may be otherwise combined and/or divided within the scope of the present invention. Accordingly, labels of the tables are for illustrative purposes and may be varied while remaining within the scope of the present invention.

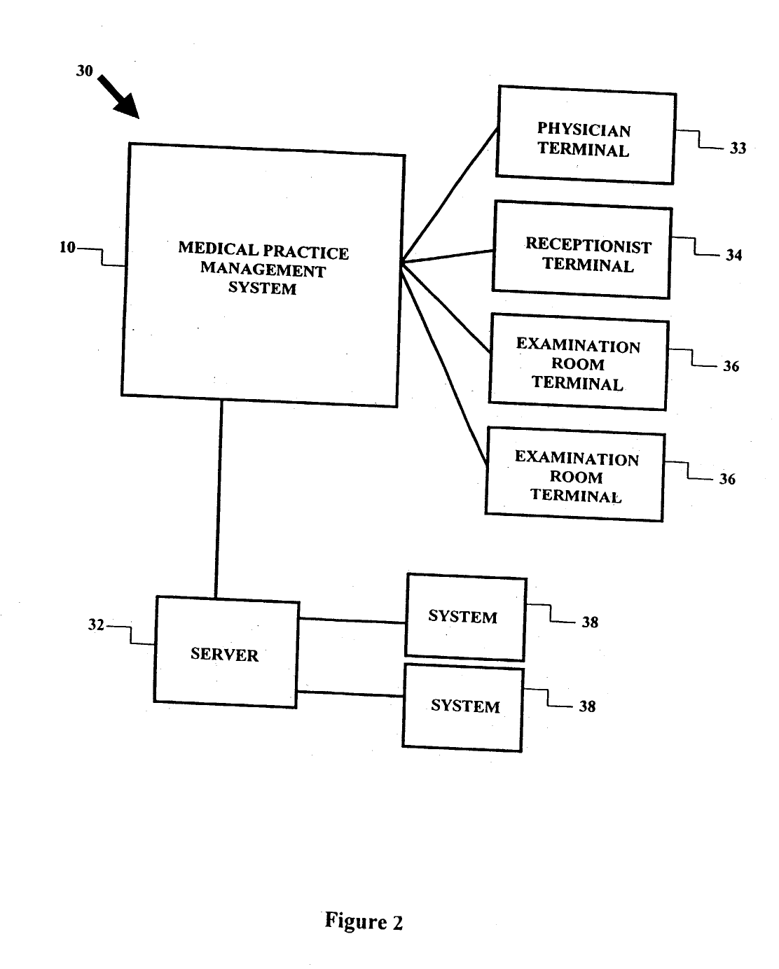

FIG. 2 illustrates an example of the present invention operating in a network environment. In this example, the network 30 includes a medical practice management system 10, a server 32, a physician terminal 33, a receptionist terminal 34, one or more examination room terminals 36, and one or more additional systems 38. Additional systems 38 may comprise additional medical practice management systems (e.g., located at additional medical offices) or ancillary systems, such as billing and other systems. In the embodiment shown in FIG. 2, terminals 33, 34 and 36 are shown as separate from medical practice management system 10. However, these terminals may be part of system 10 as output devices. Also, while terminals 33, 34 and 36 are shown to be directly connected to system 10, these terminals may be connected to system 10 in any suitable network configuration.

According to this embodiment, a receptionist may sign in the patient. This will typically take place when the patient enters the medical office. Next, a medical assistant will conduct a preliminary examination to determine the patient's vital status (e.g., blood pressure, pulse, height, weight, temperature and, optionally, ankle blood pressure). The medical assistant may also determine the patient's chief complaints and a brief description of present illness. Next, the doctor conducts an examination which includes such activities as obtaining a medical history, and conducting a physical examination. When ready to make diagnostic and management decisions, the physician may access the medical patient management computer program application using examination room terminal 36. The application facilitates the execution of the physician's decisions. Also, the application accesses the data needed to make these decisions and provides this data in an easy-to-use format. Finally, the patient leaves the medical office with a printed summary of the clinical encounter, as well as an updated summary of his or her medical history, preferably in the form of a “pocket” medical record. Optionally, the patient may be provided with a digitally stored copy of this information (e.g., on a diskette or other storage medium). The physician also maintains a computerized and printed record of the encounter.

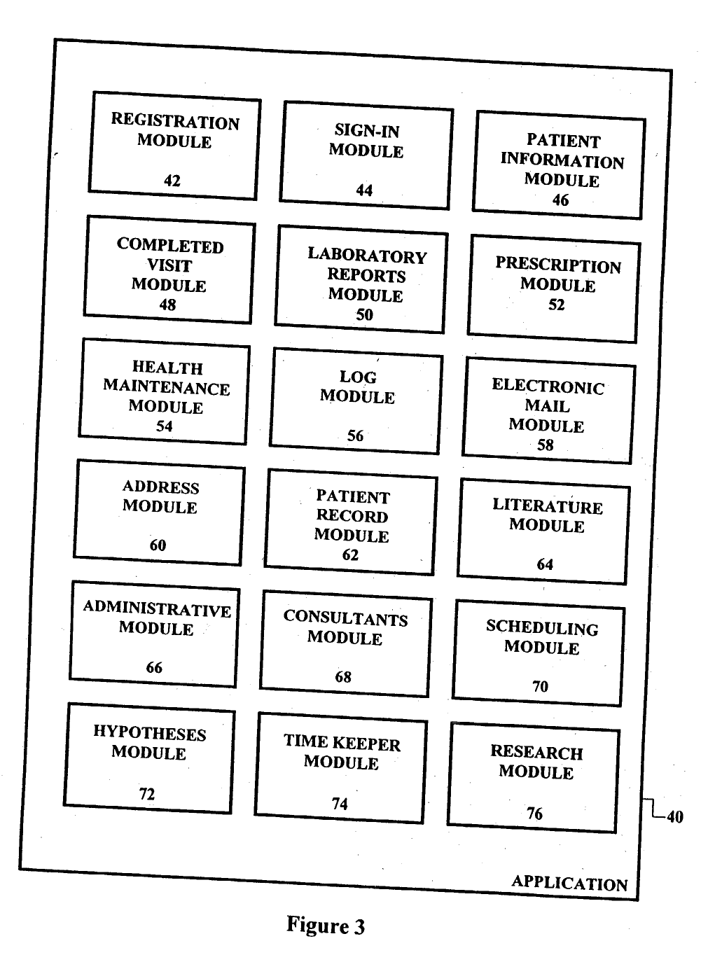

As shown in FIG. 3, system 10 includes a computer program application 40 designed to help the physician manage patients, and to provide patients with more documented information regarding their health status. As indicated above, application 40 can be run on any number of computing platforms in a variety of computing environments including standalone computers or networks. Preferably, application 40 is separate from the physician's billing system. Alternatively, application 40 can be modified to interface with the billing system to provide further automation to this aspect of the physician's medical practice.

Preferably, application 40 provides a registration module 42 which accepts information for a particular patient and stores this information in a discrete data file. This information may include such items as name, address, telephone numbers, E-mail address, insurance companies and identification numbers, and emergency contact information.

When the patient enters the medical office, the patient is “signed in” by the receptionist. One result of this process is the creation of a sign-in list. At the time of signing in, the receptionist may access a sign-in module 44 of application 40 from receptionist terminal 34. Sign-in module 44 preferably receives an identifying input, such as a patient's name or social security number, or a combination of such identifiers. Sign-in module 44 responds by automatically displaying any outstanding patient reminder follow-ups that are pending, such as an examination or laboratory test that needs to be done. If these tasks will be completed at this office visit, the receptionist has the option of marking the reminder as “completed.”

One of the key modules of application 40 is patient information module 46. Among other functions, patient information module 46 is capable of generating a concise summary of a patient's entire medical record and storing this record or causing the record to be output to output device 14. Thus, the medical record may be stored, displayed or printed. Information in this concise medical record is preferably updated each time the patient leaves the medical office, as well as whenever a clinically significant event, such as an outside procedure or consultation, is reported to the physician. For example, the medical record may be updated by way of the patient information module 46 obtaining information from a completed visit module described below.

The printed version of the medical record is preferably sized such that it may be folded and inserted into a standard wallet. Thus, the record, after folding, should be sized similar to a standard credit card. Optionally, the medical record may be credit-card sized prior to folding. In this case, however, less information may be included on the medical record. The sizing of the record allows the patient to insert the record into a wallet or similar item in order to maintain the record on the patient's person when away from the medical office. Additional printed copies are preferably included in the patient's hard copy medical file and the patient's medical chart.

Preferably, the patient's medical record includes applicable information such as the patient's demographics (name, address, telephone number, date-of-birth, Social Security Number, insurance companies and identification numbers), the patient's physician(s) with telephone numbers and similar information, the patient's consultant specialists with telephone numbers and similar information, emergency contacts with telephone numbers and similar information, the patient's major diagnoses and unresolved medical problems, operations, hospitalizations, medications, allergies, immunizations, and a listing of significant medical events.

Preferably, the medical record is organized into two main sections. The first section is the “past medical history” section and should include items such as diagnoses, unresolved medical problems, operations, hospitalizations, prescriptions, allergies, and immunizations. The second section is the “medical events” section, which should include the information in the significant medical events field. Alternatively, items in one section may be included or repeated in the other section.

The “medical events” section may include such information as office visits, telephone discussions with the patient, immunizations, allergic reactions, medication information (e.g., starting or stopping medication), all outside reports (e.g., echocardiograms, MRI's, colonoscopies, CAT scans, EKG's, etc.), consultations, appointment information (e.g., the next appointment date, time and reason for appointment and/or information regarding missed appointments), results for every medical test conducted including laboratory blood or urine tests, annual exams, Pap smears, pelvic exams, mammograms, blood pressure, pulse, height and weight measurements, Body Mass index, Ankle/Brachial index, and any missed appointments.

The significant medical events are listed in a field within the medical record according to at least one predetermined criterium. The criterium may be anything capable of determining an order of listing, such as date order or alphabetical order. Further, with respect to medical tests, and other types of events, it is preferable to have the latest result for each test type. However, because system 10 preferably stores all events, the format of the medical record may be modified so that simply a predetermined number of events are listed without regard to whether the event is the latest of its type. Alternatively, only the latest event might be included in the list for certain event types, while a predetermined number of events are included for other event types.

The significant medical events field may be partitioned into a number of subfields which may include such information as: (1) the next appointment date and purpose of next appointment; (2) health maintenance information, such as annual physical examination date; (3) missed appointments; (4) consultations and results; (5) pending follow-up reminders, such as those for blood tests or other tests; and (6) tests and results. Each of the subfields may be organized in a manner similar to that described above in connection with the description of the significant medical events field.

Preferably patient information module 46 incorporates a graphical user interface (“GUI”) to display the fields of the medical record function, and the other functions of patient information module 46, to the physician and to allow the physician to update the fields. The user interface may be embodied, for example, in a master screen. The master screen, may allow the physician to use a mouse to click on “buttons” which correspond to a variety of functions supported by patient information module 46.

In addition to the medical record function described above, these functions preferably include a diagnosis function, a medication prescription function, a recommended diet function, a recommended activity function, a follow-up reminder function, a past medical history function, a medical events function, a laboratory test results function, a consultant specialist selection function, a patient advisory function, and a fee charge function. Preferably, each of these functions is capable of generating a corresponding printed or stored form. Further, each function should be capable of updating and/or being updated by corresponding fields in the other functions. For example, if the physician enters information in a field within the diagnosis function, that information should be automatically represented by a corresponding field within the medical record function.

The diagnosis function accepts one or more diagnoses from the physician. The selection of a diagnosis is facilitated by the diagnosis function providing the physician with a list of approximately 760 commonly-used diagnoses, preferably organized according to organ system or category. The physician may add to or modify this list as desired. Alternatively, the physician can enter keywords to search an entire standard list of approximately 15,000 ICD-9 diagnosis codes provided with the module. “ICD” stands for International Classification of Diseases and “ICD-9” refers to the 9th version of this classification. The diagnosis function also displays the diagnoses in the appropriate field of the medical record. The prescription function accepts a prescription as input from the physician. The prescription may be a new prescription, a repeat prescription or a refill. The prescription function also displays the prescription in the appropriate field within the medical record. The recommended diet function allows specification and/or selection of a recommended diet. The recommended activity function allows specification and/or selection of a recommended activity. The follow-up reminder function receives information regarding any reminders such as those concerning examinations, tests or office appointments. The past medical history function can receive as input any combination of patient information such as major diagnoses or unresolved problems, operations, hospitalizations, current medications, allergies and immunizations. The medical events function accepts as input any medical event information as described elsewhere. This information may be entered directly by the user or may be imported from other functions or modules within application 40. The laboratory test results function allows the physician or laboratory assistant to enter any of a variety of test results into corresponding laboratory test fields. The consultant specialist selection function may receive information concerning a patient's preferred specialists. This function may also allow a selection of one or more specialists for specific problems. Preferably, this function also displays the selection in the appropriate location within the medical record, and is capable of printing out a consultation request form for the patient to take to the consultant. The consultation request form contains a summary of the patient's past medical history and the reason for the consultation request. The consultation request form may be electronically transmitted to the consultant. The patient advisory function may receive, display, and print for the patient special patient instructions, medication warnings, informed consent forms, etc. The fee charge function may receive, generate and display an itemized charge for an office visit. Preferably, this function may print out a Superbill showing the itemized charges for the office visit, along with the associated CPT service codes and ICD-9 diagnosis codes. “CPT” stands for Current Procedural Terminology and refers to the American Medical Association's set of service codes. These capabilities are intended to be examples only, and the various functions may provide other capabilities as appropriate to automate the tasks performed in a physician's medical practice.

Patient information module 46 may also include a medical problem function. Preferably, this function displays, in an office visit report, a list of each medical problem the patient presented to the physician, along with the duration of the problem, positive findings on physical examinations, the diagnoses, treatments, diets prescribed, activities recommended, advisories given to the patient, consultations requested, and follow-up care planned.

The various functions and fields within patient information module 46 may be preprogramed. Optionally, the various functions may be modified by the physician in order to customize the functions and fields so as to correspond to the physician's standard medical practice procedures. For example, a physician may wish to customize the past medical history function so that certain repetitive clinical events, such as common lab tests like cholesterol or PSAs, are periodically deleted from the system. Optionally, all clinical events may be stored permanently.

Other examples of the various information stored and managed by the functions within patient information module 46 include events such as office visits, lab tests, consultations, outside procedures such as echocardiograms, angiograms, X-ray and MRI reports, surgeries, hospitalizations, telephone discussions with the patient, patient follow-up reminders, appointments, etc.

Due to space constraints associated with the concept of a wallet-sized printed patient copy of the medical record, the medical record function of the patient information module 46 preferably accepts a limit to each field or group of fields associated with the medical record function. For example, the number of medical events may be limited to a number of events corresponding to the allotted space in the significant medical events field of the medical record (e.g., when printed for the patient to use as a “pocket” medical record). For instance, it has been found beneficial to limit the number of medical events automatically displayed in the significant medical events field, depending upon the length of the description of each event, to about 15-30 events. These may be, for example, the most recent events. The remaining events may be erased, but are preferably permanently stored for retrieval when needed. When retrieved, these events may be displayed or printed out in their entirety.

Preferably, at the completion of an office visit, the patient is given a printed report including the following information, where appropriate:

(1) A charge slip showing the charges attributable to the current office visit. The charge slip is preferably in a “Superbill” format, which allows it to be submitted directly to an insurance carrier;

(2) A consultation request form. For example, if the doctor requests a consultation, a form may be printed, preferably showing the referring physician's name and address, the patient's name, address and telephone number, the consultant's name, speciality, address, phone number, reason for consultation, and a brief summary of the patient's past medical history (including such information as major diagnoses, operations, allergies, current medicines and immunizations);

(3) Prescriptions. Preferably, in addition to information concerning medication and dosage, the prescription printout also includes the patient's pharmacy name, address, and telephone and facsimile numbers;

(4) A diet form, including a diet recommended by the physician;

(5) A patient advisory form. Preferably, this information includes any special instructions or warnings that have already been discussed with the patient (e.g., an exercise instruction sheet, a weight reduction program, extensive discussion on dietary supplements, etc.);

(6) An updated printed patient copy of the patient's concise medical record as discussed above;

(7) An office visit summary form, which includes a listing of each of the patient's chief medical complaints, positive findings on examination, the vitals (e.g., blood pressure, pulse, height, weight, temperature, BMI (Body Mass Index)), and diagnoses together with associated prescriptions, follow-up dates and reasons, and other recommendations.

Application 40 may also include a completed visit module 48. Preferably, completed visit module 48 accepts as input, and displays as output, information concerning the critical data associated with a patient's office visit. Preferably, the application 40 is capable of organizing this information and transferring it into specific logical compartments for easy retrieval and understanding by the physician and patient.

According to this embodiment, for each patient visiting the physician's office, a medical assistant first enters that patient's vitals (e.g., blood pressure, pulse, height, weight, temperature, etc.) After the physician finishes examining the patient and making management decisions, this information is entered into application 40 in a series of steps. First, for each medical problem, a diagnosis is entered. Second, for each diagnosis, a recommended treatment is entered. Third, a follow-up procedure is entered.

With respect to the diagnosis step, the physician can select a diagnosis from the patient's previous diagnoses (e.g., from a file that includes the patient's major diagnoses) or the physician can enter a new diagnosis. To enter a new diagnosis, the physician preferably enters either a few letters of the diagnosis description, or the ICD code, if known. Preferably, completed visit module 48 searches the diagnosis file for one or more matches. If there is only one found, the program enters this into a diagnosis field within completed visit module 48. If there is more than one match, the program preferably outputs to a display a list of possible diagnoses, from which the physician selects the appropriate one (e.g., by simply using a mouse to click on the appropriate selection). If the physician has entered a word description of the diagnosis, the program preferably automatically enters the ICD code as well. Also, if the ICD code is not the most specific code, the program preferably automatically alerts the physician of this situation, and displays a list of more specific ICD codes from which the physician may select. This process of recording diagnoses and generating ICD codes facilitates conformance to Medicare's requirement that physicians must always use the most specific ICD code available. The program also automatically enters the current date for the diagnosis.

Preferably, when the physician is entering a diagnosis for a patient, the physician has the option of viewing and selecting from a list of the common diagnoses used in that particular physician's office. The physician selects one by simply clicking on it. The program provides the name and the ICD code. The physician may also have the option of displaying and selecting from a list of common diagnoses used in the particular physician's office, which are associated with a specified organ system of the body (e.g., such as musculo-skeletal, cardiovascular, skin disorders, gastrointestinal, etc.).

Preferably, the physician can also enter CPT service codes, and the program will automatically display a list of ICD diagnosis codes which Medicare requires for approval of coverage for the specified service. For example, if the physician orders a Complete Blood Count (“CBC”) for a Medicare patient, Medicare will not cover the payment for that test if the associated ICD diagnosis code is not among those it has designated as appropriate for that service (e.g., the ICD code for anemia).

The completed visit module 48 also allows the physician to classify each diagnosis, for example, as a major diagnosis (in contrast to a minor, temporary diagnosis, such as a sore throat), or an unresolved, ongoing medical problem, such as diabetes or hypertension. The diagnosis, thus classified, may be stored in an appropriate field within the medical record. For example, if the physician classifies a diagnosis as a major diagnosis, the program stores the diagnosis in a “Major Diagnoses” field within the medical record.

Preferably, the diagnosis function also allows the selection of a layman's description to be associated with each diagnosis. In many cases, the official description for an ICD diagnosis or CPT service is not easily understood by the patient. Thus, application 40 allows the physician to define a “layman's description” for any diagnosis or service, which is more easily understood by the patient. The layman's description can be displayed in connection with the official diagnosis and included, for example, in the patient's printed copy of the medical record.

With respect to the treatment step, once a diagnosis has been selected, the completed visit module 48 may automatically display a list of all possible treatments for the diagnosis, including medications, diets, and activities, for the doctor to select from. Preferably, these diagnosis-related treatments are provided in part by application 40, but may be supplemented by the doctor.

When the physician enters a diagnosis, application 40 preferably generates and displays a list of suggested, predetermined treatments for the selected diagnosis. The physician may then simply click on the desired treatment. Preferably, the predetermined treatments each include prescription information and patient instructions. The physician may either accept the suggested treatment or modify a selected treatment and then accept it. Alternatively, if the desired treatment is not in the list, the physician may formulate and enter a “new” treatment. Preferably, once a “new” treatment is entered (which may include prescription information), the treatment remains associated with the selected diagnosis for display along with the other treatments when the physician subsequently selects the diagnosis.

Preferably, as stated, whenever the physician enters a diagnosis, the program automatically displays a set of treatments suggested for that particular diagnosis. To generate a prescription and also enter the treatment in the patient's electronic record, the physician simply clicks on the desired treatment displayed in the list.

Application 40 may be provided with a predetermined set of such suggested treatments, but the physician may modify these and add any treatments for any diagnosis. Also, when entering a set of treatments for a specific diagnosis, application 40 allows the physician to associate the set of suggested treatments to any other diagnoses.

For example, the ICD code for dementia is 290. However, there are many types of dementia, with their own codes. For instance, ICD 290.1 is presenile dementia; ICD 290.11 is presenile dementia with delirium; ICD 290.s is senile dementia; ICD 290.4 is arteriosclerotic dementia; and ICD 290.8 is “other specified senile psychotic conditions.” When the physician enters a set of suggested or possible treatments for ICD code 290, the physician may associate that same set of suggested treatments with all the other above-mentioned diagnoses beginning with 290.

Diets may also be automatically generated and, for example, printed out for the patient with a click of the mouse. The diets may be previously entered by the physician or may be predetermined and delivered with system 10.

Preferably, after a treatment has been entered, the program automatically displays the patient's allergies so that the physician can make a decision whether or not it is safe to prescribe to patient the medication associated with the selected treatment. Application 40 preferably communicates this information to the patient information module 46 to automatically update the patient's medical record. For example, the medical record will be updated to reflect the current medication. Preferably, the appropriate functions within the patient information module 46 are updated, such as the patient's past medical history file.

Preferably, application 40 is capable of performing calculations to generate the value of certain fields which are formulaic based on the values entered for certain other fields. For example, when a patient's vitals are entered, the program preferably automatically calculates the patient's BMI (Body Mass Index), and records this in the medical record. The BMI is currently considered the most clinically useful measure of a person's degree of obesity or lack thereof. As another example, if the user enters the patient's supine ankle and brachial blood pressures, application 40 may automatically calculate the Ankle/Brachial index. This index is a measure of the degree of hardening of the arteries (atherosclerosis) of the lower extremities, and thereby a measure of the flow of blood into the lower extremities. Other indicators that may be automatically calculated include, but are not limited to, pulse pressure, and weight and height changes.

The completed visit module 48 may also include a questionnaire function. For any diagnosis code (including ICD codes), including especially codes defining a patient's chief medical complaints (e.g., sore throat, chest pain, etc.), a set of questionnaires is provided, which comprise the questions most physicians would typically ask the patient when the patient presents the physician with the particular chief complaint. The physician can modify the questionnaires as desired. The physician can also create new questionnaires for any desired chief complaint.

In practice, an office medical assistant may enter the chief complaints of the patient and then go through each associated questionnaire with the patient. The questionnaire may then be modified by the physician before, during or after examination and management of the patient. Preferably, this is accomplished before examination and management of the patient. At the completion of the examination, the questions and answers may be printed out, stored temporarily or permanently in the computer database, or deleted.

With respect to follow-up procedures, completed visit module 48 accepts as input and displays as output, any applicable follow-up information. For example, to enter a follow-up reminder for the patient, the physician enters data into fields related to follow-up visits. According to one aspect, the physician may enter three fields of information including: (1) the target date; (2) the service desired on the target date; and (3) the medical reason for the follow-up service. Examples of follow-up services include office visits, lab tests, and condition reports. There are also a number of follow-up reminder choices from which the physician may select. Preferably, there are at least four kinds of follow-up reminders available including: (1) medical office mail to patient; (2) patient telephone call to medical office; (3) medical office telephone call to patient; and (4) patient telephone call to medical office only if medical problem is not resolved by treatment. Other possibilities may exist to cover alternative methods of communication (e.g., facsimile or E-mail), communication with other parties (e.g., with a medical assistant or a consulting physician), and other conditions precedent (e.g., patient telephone call to medical office if a certain condition exists or does not exist).

For the “mail-to-patient” follow-up, the program preferably automatically initiates an output in the form of a printed reminder letter to the patient at a predetermined time prior to the target date (e.g., one week before the target date). Preferably, this function is automatically performed when application 40 is first accessed on a given day. Optionally, if system 10 is operating continuously, this function may be accomplished at any preset time of day. Preferably, the letter to the patient includes all necessary information, including the patient's mailing address, target date, service desired, and medical reason for the service. This automation reduces the amount of administrative effort required to perform the reminder function within a medical practice. It also enhances the quality of patient care and satisfies medicolegal requirements by reliably informing patients as to when and why a follow-up service is required, as well as the significance of the follow-up service.

If the patient fails to respond to the reminder, a second reminder (e.g., an identical letter) is preferably generated at a predetermined later time. If the patient fails to respond to the second reminder, another follow-up reminder may be sent, and so forth. Preferably, the follow-up procedure function may be modified by the physician to customize the number, form, and communication method of the follow-up reminders. Also, the follow-up procedures function may be enhanced to provide notice to the physician, or another designated person, of a patient's failure to respond to reminders. For example, the program may automatically initiate an E-mail message to the physician that a patient has failed to respond to either a first or a second reminder letter.

The program may also cause the delinquency to be recorded and entered into an appropriate field within the patient information module 46. Preferably, each follow-up reminder entered is automatically entered into that patient's medical record. Any previous reminder that has been fulfilled may be automatically removed from the active data file, so that the patient has displayed on the concise medical record only the current follow-up reminders. However, these reminders are preferably stored permanently for future retrieval if necessary. As discussed, the reminder preferably describes the target date, the service to be rendered, the reason for the service, and the medical significance of the service. For example, the reminder might be for a date one month away from the current visit. The service to be rendered might be “prothrombin time.” The reason for the service might be “taking medication coumadin, a blood thinner.” The medical significance might be “if the blood is thinned too much, there is a risk of hemorrhage or bleeding into the brain, kidney, intestine, or other critical part of the body.” This information can be used by the patient as a printed reminder in place of other, more time intensive, means such as the traditional handwritten card. Also, this type of information may be legally required, but not typically provided due to the lack of an automated system as described herein.

The completed visit module may also include a number of other functions, which may be represented, for example, as buttons on a display screen. For example, a “patient advisory” function may be provided. By clicking on a patient advisory button, the physician may select from a list any advisory to display and then print out the information for the patient. Such information may include, for examples, informed consent forms, instructions for preparing for a Treadmill Stress Test, an exercise program for a specific purpose, instructions for taking certain medications, etc.

An “evaluation/management determination” function may also be provided. By clicking on various ones of a grid of buttons, the physician may determine (e.g., according to the rules required by Medicare) the proper level of office visit service rendered to the patient for properly billing the patient.

An “enter charge” function may also be provided. This function displays an on-screen charge slip. The physician clicks on each charge item to enter it. Preferably, for each item, a diagnosis is entered for billing purposes. The physician may be provided with the option of entering additional diagnoses (e.g., two additional diagnoses) for each charge item. At completion of an office visit, a charge slip is printed out, which can be used to enter the charge information into the physician's preferred billing program, and also to give to the patient to document the charges attributable to the present office visit, and for the patient's own insurance filing, if desired. Additionally, patient charges may be automatically entered into a patient's electronic account. An interface may be provided between the physician's billing program and system 10, which provides for the direct transmittal of charge information from system 10 to the billing program.

System 10 may also include a “laboratory reports” module 50.

Laboratory reports module 50 allows a person, such as a medical assistant to enter a patient's laboratory test results. Later, the physician may access module 50 to interpret the test results. For each patient, the doctor preferably views which laboratory tests were performed and the values of the tests. For any quantitative test (e.g., cholesterol, PSA, etc.), the physician may also view, if desired, a graph of the patient's results for all of such tests. This provides a tool for the physician to analyze trends in the patient's medical status with respect to the particular test being analyzed. Preferably, For each patient, the physician is required to enter an assessment, recommendation, and follow-up recommendation for each test result. The physician may also enter a patient follow-up reminder. Once each of the test results for a particular patient has been addressed, module 50 presents the physician with a subsequent patient. Alternatively, the physician may address all of a particular type of test result for all patients and then address a different type of test result for all patients. Alternatively, the physician may deal with a selected or predetermined group of patients and then deal with a subsequent group of patients. Thus, module 50 may allow the physician to customize the order in which the physician addresses laboratory test results.

When the physician has completed a session with laboratory results module 50, the program preferably prints out duplicate copies of the lab reports, with the physician's interpretations, in a format suitable for mailing to a patient or other applicable person, such as a consultant. Module 50 may also provide for the direct transfer of this information to other modules of application 40. For example, this information may be electronically transferred to patient information module 46 for inclusion in a patient's medical record. According to one feature, the information is used to “create” a clinical event reflected in the concise “pocket” medical record. Also, laboratory test results may be directly transferred (e.g., electronically) to the medical office and imported into one or more appropriate modules within application 40 (e.g., into the laboratory results module 50).

Application 40 may also include a “prescription” module 52. Module 52 may facilitate various activities in connection with specifying and managing a patient's prescriptions. Module 52 may interface with other modules of application 40 as appropriate including, for example, the treatment function of completed visit module 48. For example, when a patient calls in to request a refill of their medication, a medical assistant may enter this request into prescription module 52. Later, the physician may access module 52, view the request along with relevant patient information, and click an appropriate button to approve, modify, or reject the request. If the request is approved or approved with a modification, module 52 may initiate a printout of the prescription, which is preferably complete with all of the relevant pharmacy information, and which may also include other information such as a patient advisory. Preferably, prescription module 52 electronically tracks medication used for treating particular diagnoses and particular patients. Thus, statistics may be generated concerning medication in relationship to other types of information such as diagnoses or patient demographics.

Prescription module 52 preferably interfaces with other modules of application 40, so that it can distribute and receive information to and from corresponding fields within the other modules. For example, prescription module 52 should be capable of updating corresponding fields within patient information module 46.

The prescription may be delivered to the pharmacy by any method acceptable to the patient and physician. For example, the patient may hand deliver the prescription or have the medical assistant fax the prescription. Alternatively, system 10 may be provided with an electronic link, such as an extranet or Internet connection with the pharmacy's computer network so that the prescription is electronically delivered to the pharmacy. Module 52 may also incorporate an electronic signature function, which stores the physician's signature in electronic form and retrieves the signature upon request from an authorized user (e.g., the physician). Preferably, the prescription module 52 is provided with appropriate electronic safeguards such as password protection and encryption so as to ensure only authorized prescriptions and to protect patient confidentiality.

In practice, prescription module 52 may operate as follows. When a patient calls in requesting a refill of their current medication, the medical assistant enters this request into the prescription module 52. The program displays the patient's current medications, including name, dosage, and frequency of taking the medication. With a click of the mouse, the medical assistant enters the requested medication name, dosages, frequency of taking, number of pills and number of refills requested. The assistant also enters any special instructions from the patient, including a preferred pharmacy, and whether to fax the refill to the pharmacy, send the prescription to the patient, or whether to have the pharmacy deliver the medication to the patient's home.

Later, the physician goes through each medication refill request. Since all pertinent information is displayed on-screen, only minimal time is needed for the physician to analyze the request and make a determination as to whether the request should be approved or denied. The physician preferably sees the patient's current medication, the last time it was refilled, any special comments about the patient, the last time the patient was seen in the office, and the patient's major diagnoses and allergies. In addition to displaying this information for decision-making purposes, the program prints out the pertinent information for inclusion in the electronic or printed prescription.

Application 40 may also include a “health maintenance” module 54. This module allows the physician to specify routine or periodic medical events. For example, module 54 may allow the physician to specify routine annual examinations. The physician specifies the recommended tests to be performed and any other special instructions or disclaimers. This information can be tailored to physician-specified patient criteria, such as age, weight, sex and ethnicity. At predetermined intervals (e.g., on the first workday of each month), the program searches a data file associated with health maintenance module 54 for any patient that satisfies physician-determined criteria. Preferably, the list of patients is further narrowed by one or more additional criteria, such as birth date. For example, all of the qualified patients whose birth date falls within the current month may be identified by module 54. The program may automatically print out appropriate patient form letters specified by the physician for patients meeting the specified criteria.

In practice, as an example, the health maintenance module 54 may operate as follows. The physician enters age and sex parameters, and creates a form letter, which will automatically printout during the patient's birth month, to remind the patients conforming to these parameters that it is time for an annual examination. The form letter describes the recommended laboratory tests and examination procedures. If the patient fails to respond to a first mailing, the program can generate additional reminders. Delinquency notices may also be created and forwarded to an appropriate individual, such as the physician.

Application 40 may also include a “log” module 56. Preferably, log module 56, summarizes patient traffic for a specified period of time (e.g., daily). For example, log module 56 may, at the end of each day, provide a printout that lists the patients signed in for the day and any significant events such as delinquent reminders or missing data in critical fields that should have been entered. Preferably, during operation of other modules, appropriate events are classified as significant or non-significant for purposes of the operation of log module 56. As with the other modules, log module 56 may interface with other modules of application 40 or with other components of system 10 (e.g., database 18) in order to retrieve appropriate information. Log module 56 is preferably represented in a GUI form to the physician and may be modified by the physician according to a preferred format.

Application 40 may also include an “electronic mail” module 58, which preferably interfaces with the other modules of application 40. Preferably, electronic mail module 58 at least supports an intranet E-mail system, in which any office personnel can send an E-mail message to any other office personnel. Preferably, the program allows “broadcast messages” from the physician to groups such as “all employees,” “all physicians,” or “all office personnel.” The program allows transfer of Internet E-mail into the medical office intranet E-mail system, and subsequent distribution to any particular office personnel.

Preferably, the electronic mail module 58 supports at least the following functions. A user may send E-mail messages to any other person in the intranet and receive responses from the recipients. A user may send “broadcast messages.” A user may send E-mails to their own address (e.g., as a reminder). A user may create an E-mail message and specify a date and time at which the E-mail is to be delivered. Preferably, the recipient of the E-mail cannot alter the sender's message. Preferably, the sender (or other recipient) cannot alter the recipient's response. The E-mail system is password-protected. Patient failures in responding to follow-up reminders automatically generate an E-mail report of the failure. The E-mail report can be automatically distributed to any selected recipient or group of recipients. If one of the office personnel fails to perform a certain task for which an entry is required by application 40 within a certain time period, an E-mail message may be automatically generated and sent to any selected recipient or group of recipients. For example, an assistant may be tasked with telephoning a patient to obtain a condition report requested by the physician and the assistant may be required to enter completion of this task in application 40 (e.g., in connection with the follow-up procedures function of completed visit module 48). If the assistant fails to complete the task and make the appropriate entry, an E-mail message is automatically generated and sent to the physician notifying the physician of the delinquency. A user is alerted if a recipient of the user's E-mail fails to respond to the E-mail within a given time period or by a predetermined or designated date and time. The user can access a function that displays all E-mails requiring a response. A user is alerted to new messages upon logging onto application 40. Storage folders are available and may be established for storing E-mail messages.

Application 40 may also include an “address” module 60. Preferably, address module 60 receives and outputs several fields of contact information for anybody that may be represented within system 10 (e.g., physicians, assistants, patients, consultants, pharmacies, etc.). The fields should at least include name, address, primary and secondary telephone numbers, emergency contact information, facsimile number, E-mail address, and a note field. Preferably, address module 60 interfaces with the other modules of application 40. Thus, for example, prescription module 52 can obtain “address” information for a pharmacy by retrieving this information from address module 60.

Application 40 may also include a patient record module 62. Preferably, patient record module 62 is capable of generating a complete patient history, which can be stored or transmitted to another location (e.g., via facsimile or Internet). The complete patient history preferably includes every piece of information from all other modules with respect to a particular selected patient or selected group of patients. However, the format of the complete patient history may be modified to customize the organization and content of the information.

In operation, for example, a physician can transmit a patient's records to another of the physician's offices or to a specialist consultant. The records may be updated and returned to the original office. Preferably, the complete patient record includes all of the information on the medical record document of the patient information module 46, and the patient's original laboratory test data, which allows the doctor to view these data in graph display form for trend analysis.

Application 40 may also include a “literature” module 64. Literature module 64 may receive as input any literature specified, for example, by the physician. For instance, the physician may specify that a certain medical journal article is input into the literature module 64 for storage and retrieval at a later time. As an example, the physician may wish to input and store Medline abstracts. Medline is the National Library of Medicine's Internet Grateful Med database. A Medline abstract may be downloaded to a user's computer hard drive, and then imported into literature module 64. Application 40 automatically distributes the data from the downloaded document into appropriate fields within literature module 64. For example, these fields may include “journal name,” “date of publication,” “authors,” “title,” and “abstract.” Keywords may be automatically created for each abstract as it is being imported. The keywords may be used in subsequent searching and retrieval processes. The user may also add abstracts and keywords manually. The abstracts may be printed out by topic or keyword. The literature module 64 preferably supports automatic generation of the content of certain identifier fields where the literature is in a fixed format (e.g., Medline). Alternatively, the literature module 64 may prompt entry of information regarding the literature into appropriate fields. The physician may access the literature at any time during operation of application 40. Preferably, module 64 interfaces with the other modules so that the literature information may be retrieved while the user is operating within any of the other modules within application 48. For example, if the physician is operating in the diagnosis function of completed visit module 48, it may be advantageous to access any literature associated with the patient. This may aid the physician in selecting an appropriate diagnosis.

Application 40 may also include an administrative module 66. Preferably, administrative module 66 facilitates and automates such functions as printing letters and labels, and addressing envelopes. This module also automates the printing of patient chart labels (which may be printed on adhesive labels), which may show such information as name, date-of-birth, telephone number, social security number, year of last visit, and date of last visit. Laboratory labels may also be generated (e.g., on adhesive labels) and may contain all the information typically required by laboratories on their requisition forms. For example, in connection with blood test requisition forms the information might include patient name, address, date of birth, and insurance.

Application 40 may also include a “consultants” module 68. The consultants module 68 acts as a repository for information concerning the physician's preferred consultants. The information may include contact information as well as comments and notes regarding the consultants' specialities, articles, past performance, fees, characteristics, personal description, etc. The consultants module 68 may comprise a separate module or may be part of another module. For example, the consultants module 68 may be incorporated into address module 60. Also, consultants module 68 may include a field for tying various consultants to particular patients. As with other modules, consultants module 68 should interface, where applicable, with other modules that may need to access information regarding consultants.

Application 40 may also include a “scheduling” module 70. Preferably, the scheduling module supports scheduling all appointments including patient appointments and any other appointments occurring as part of the normal course of operating a medical office. For example, scheduling module 70 should support vendor appointments such as those involving visits by pharmaceutical representatives. This module should be password-protected such that only certain personnel may alter appointments. As with the other modules, the scheduling module 70 should interface with the other modules so as to send information or make it available, and to retrieve information when necessary. For example, when an appointment is entered for an existing patient, the scheduling module 70 should interface with the completed visit module 48 to obtain the purpose of the appointment. The scheduling module should be configured such that it can either mirror information already entered in other modules, or receive all of the schedule information and output this information to other modules as appropriate.

Application 40 may also include a “hypotheses” module 72. Hypotheses module 72 may be used to generate hypotheses concerning the relationship between variables, such as different medical criteria and conditions. Preferably, hypotheses module 72 interfaces with literature module 64 to accomplish this function. According to one aspect, hypotheses module 72 accesses the literature stored in connection with literature module 64 and uses this information to create hypotheses regarding the connection between medical variables.

Preferably, for each piece of literature stored in connection with literature module 64, keywords are entered either automatically or manually by the user. Each of these keywords is classified as either an independent variable, a dependent variable or both. Preferably, if a keyword is classified as a dependent variable, it is tied to at least one independent variable. For example, if the user is storing an article on Alzheimer's disease, the user may enter “Alzheimer's” as a keyword and classify it as a dependent variable. The user may enter other keywords, including the various things known to be related to Alzheimer's disease, such as “apolipoprotein E,” “vitamin B12 deficiency,” “head trauma,” etc. These may be classified, for example, as both independent (e.g., with respect to “Alzheimer's”) and dependent (e.g., with respect to other related variables). Similarly, when the user enters an article on apolipoprotein E, he enters the related variables, such as atherosclerosis. Again, “atherosclerosis” may be classified as both independent (e.g., with respect to “apolipoprotein E”) and dependent (e.g., with respect to other related variables). When the user enters an article on “atherosclerosis,” he enters the related keywords “saturated fats,” “cholesterol,” “folic acid,” “exercise,” “insulin,” etc. These are classified as independent variables.

Once the data file has a number of entries, then the user can request the program to generate a hypothesis for any topic, for example, “Alzheimer's.” The program then searches the keywords for each article on Alzheimer's disease, and creates a set of unique Alzheimer's-related keywords. In this example situation, this set of keywords would include “apolipoprotein E.” Each of these unique keywords is then used, in a similar manner, to create another set of unique keywords which are related to their individual topic. In the example, one of these is “atherosclerosis.” From the articles on atherosclerosis, another set of unique keywords is created, which reveal further parameters related to atherosclerosis. These are the independent variables noted above.

One of the possible hypotheses is simply “Alzheimer's disease is related to one of the independent variables saturated fats, cholesterol, folic acid, exercise, insulin, etc.” In addition, the program may tally the number of hits for an independent variable keyword, and provide a listing in order of the “strength” of the connection of a dependent variable to the independent variable.

In addition to this particular function, the hypotheses module 72 may incorporate any known knowledge discovery technique for manipulating data to reach or generate hypotheses, discover relationships among data, reach conclusions, create rules, etc.

Application 40 may also include a “time keeper” module 74. Preferably data is entered both by employees and an office administrator. In addition to keeping track of arrival and departure time for each employee, the program keeps track of each employee tardiness, authorized and unauthorized absences, sick leaves, vacation time taken, etc., and calculates the gross salary for the designated work period. The various needed reports are printed out on demand. Time keeper module 74 interfaces with other applicable modules of application 40. For example, module 74 may interface with electronic mail module 58 to cause an E-mail to be sent to the physician if any employee is tardy more than three times during a month.

Data that may be entered by employees can include such information as “start of day,” “end of day,” “start lunch,” “end lunch,” etc. These events may be preconfigured and represented in graphical format so that the employee user simply clicks on the appropriate event. Information that may be entered by an office administrator may include such things as employee demographics, position, salary or hourly pay rate, vacation time protocol, sick leave protocol, grace time allowed or tardiness, overtime protocol, etc. Preferably, an office administrator may modify the entries of an employee only when authorized by the physician. However, such safeguards may be customized according to the physician's standard medical office procedures.

The time keeper module 74 may also include an encounter timing function. This function may be used to keep track of the progress of a patient's visit at the medical office. For example, a timer may be started when the patient signs in, or at some other time such as when the patient's vitals are entered. If the physician is not immediately available, the timer pauses until the physician returns. The timer continues when the physician returns and views the entered vitals. It continues while the physician takes the patient's medical history, examines the patient, and enters the diagnoses, treatments and other appropriate information in connection with application 40. When finished, the timer stops and records the duration of the clinical encounter on the physician's record. The timing of each clinical encounter is stored electronically, and can be analyzed statistically by diagnosis, to determine, for each physician, the average amount of time taken for managing each specific diagnosis. Additional timing mechanisms may be incorporated to other events during the visit such as, for example, the waiting period between an encounter with the medical assistant and a subsequent encounter with the physician. The time keeper module 74 may interface with the other modules. For instance, time keeper module 74 may provide timing information to the billing functions of completed visit module 48 or patient information module 46.

Application 40 may also include a “research module” 76 to assist in and simplify the performance of research on selected patients. Preferably, each patient is designated as belonging to one or more particular research groups (or a placebo group). Data may be automatically collected for a given research project whenever the value of any of the patient's tests is entered into the computer. Whenever the research director desires, a research report can be generated, indicating the values of the research parameters for each patient for each research group. These data can be printed out, downloaded into electronic storage, or imported into another application (e.g., such as a spread sheet).

Application 40 is preferably capable of reconciling information in the various modules. The various modules in application 40 may receive input of the required information either directly from a user or from other modules, where the same information might be entered. If entered directly by the user, the module should be capable of distributing the information to other modules as appropriate. This can be accomplished by any acceptable method including direct transmittal of information from module to module. Alternatively, fields that are common to multiple modules or functions may be stored in a master repository accessible by the various modules. Other methods of reconciliation and information transmittal may be used.

The entire system 10 should be password-protected as appropriate. The password protection should be flexible such that certain modules may be accessed with or without passwords or accessible to only certain groups of people, at certain times of day, etc.

The above-described embodiments are intended as examples only and are not intended to limit the scope of the invention. It will be appreciated that these specific embodiments may be modified within the scope and spirit of the invention. For instance, the invention is not limited by the specific modules, functions, or configurations described. The various functionality provided within application 40 may be provided on different modules than those described, on multiple modules, or in different configurations. The descriptions are intended as examples only.

What is claimed is:

1. A medical practice management system, comprising:
at least one processor;
at least one input device coupled to the at least one processor for inputting information to the at least one processor;
at least one output device coupled to the at least one processor for outputting information from the at least one processor; and
at least one application executable by the at least one processor, the application comprising at least one module, the at least one module comprising a patient information module, the patient information module comprising:
a medical record function for generating a medical record comprising one or more fields, the one or more fields including a medical events field, the medical record function comprising a medical events function for receiving as input from the at least one input device one or more medical events and the at least one processor analyzing the medical events to determine an order of the medical events according to at least one predetermined criterium and displaying, in the medical events field, a listing of the one or more medical events in the determined order; and
at least one other patient information function having one or more fields and operable to receive patient information from the at least one input device, the at least one processor processing the patient information to display the processed patient information in at least one of the one or more fields of the medical record, the at least one other patient information function adapted to share information with the medical record function and to automatically process information received by the medical record function.

2. The medical practice management system of claim 1, wherein the patient information module is operable to generate, using at least one of the output devices, a printed version of the medical record that may be inserted into the patient's wallet.

3. The medical practice management system of claim 2, wherein the printed version of the medical record is approximately credit-card sized.

4. The medical practice management system of claim 2, wherein the number of medical events displayed in the medical events field of the printed version of the medical record is limited to a particular number based on the size of the printed version of the medical record.

5. The medical practice management system of claim 1, wherein the one or more medical events are processed by the at least one processor to classify the one or more medical events according to the at least one predetermined criterium, the at least one predetermined criterium comprising the level of significance of the one or more medical events.

6. The medical practice management system of claim 1, wherein the at least one other patient information function further comprises a diagnosis function for facilitating entry, using the at least one input device, of one or more diagnoses corresponding to at least one patient medical problem, and wherein the at least one processor processes the one or more diagnoses to display the one or more diagnoses in at least one of the one or more fields of the medical record.

7. The medical practice management system of claim 1, wherein the at least one other patient information function comprises a medication prescription function for facilitating entry, using the at least one input device, of one or more prescriptions corresponding to at least one patient medical problem, and wherein the at least one processor processes the one or more prescriptions to display the one or more prescriptions in at least one of the one or more fields of the medical record.

8. The medical practice management system of claim 1, wherein the at least one other patient information function comprises a recommended activity function for facilitating entry, using the at least one input device, of one or more recommended activities corresponding to at least one patient medical problem, wherein the at least one processor processes the one or more recommended activities to generate a recommended activity form and update at least one corresponding field in another one of the patient information functions.

9. The medical practice management system of claim 1, wherein the at least one other patient information function comprises a follow-up reminder function for facilitating entry, using the at least one input device, of one or more follow-up reminders corresponding to at least one patient medical problem, wherein the at least one processor processes the one or more follow-up reminders to generate a recommended activity form and update at least one corresponding field in another one of the patient information functions.

10. The medical practice management system of claim 1, wherein the at least one other patient information function comprises a laboratory test results function for facilitating entry, using the at least one input device, of one or more laboratory test results corresponding to at least one patient medical problem, wherein the at least one processor processes the one or more laboratory test results to generate a laboratory test results form and update at least one corresponding field in another one of the patient information functions.

11. The medical practice management system of claim 1, wherein the at least one other patient information function comprises a consultant specialist selection function for entry, using the at least one input device, and selection of one or more consultant specialists corresponding to at least one patient medical problem, the at least one processor operable to process the entry and selection to generate a consultation request form.

12. The medical practice management system of claim 1, the at least one module further comprising a completed visit module, the completed visit module adapted to receive information associated with a patient's medical office visit using the at least one input device, and the at least one processor processing the received information to update at least one field associated with the patient information module based on the received information.

13. The medical practice management system of claim 1, the at least one module further comprising a prescription module, the prescription module adapted to receive information associated with a patient's medical prescriptions using the at least one input device, and the at least one processor processing the received information to update at least one field associated with the patient information module based on the received information.

14. The medical practice management system of claim 1, the at least one module further comprising an electronic mail module, the electronic mail module interfacing with one or more other modules, the at least one processor operable to process information within the one or more other modules to automatically generate an electronic mail message in response to a condition existing within the one or more other modules.

15. The medical practice management system of claim 1, the at least one module further comprising a patient record module, the patient record module adapted to receive, from another of the at least one module, information associated with a patient's complete medical history, and the at least one processor processing the received information to generate a complete patient history.

16. A medical practice management system, comprising:
at least one processor; and
at least one application executable by the at least one processor, the application comprising:
a patient information module, the patient information module comprising a medical record function for generating a medical record comprising one or more fields, the one or more fields including a medical events field, the medical record function comprising a medical events function adapted to receive information associated with one or more of a patient's medical events, and the at least one processor analyzing the one information associated with the one or more of the patient's medical events to determine an order of the information according to at least one predetermined criterium and displaying information associated with one or more of a patient's medical events in the medical events field in the determined order;
a laboratory reports module adapted to receive information associated with the patient's laboratory medical tests and the at least one processor processing the information associated with the patient's laboratory medical tests to automatically update at least one field associated with the patient information module;
a prescription module adapted to receive information associated with the patient's medical prescriptions, and the at least one processor processing the information associated with the patient's medical prescriptions to automatically update at least one field associated with the patient information module; and
a completed visit module adapted to receive information associated with the diagnosis, treatment and follow-up of at least one patient medical problem, the at least one processor processing the information associated with the diagnosis, treatment and follow-up of the at least one patient medical problem to automatically update at least one field associated with the patient information module.

17. A software program application for use in a medical practice management system, the application comprising at least one module, the at least one module comprising a patient information module, the patient information module comprising:
a medical record function for generating a medical record comprising one or more fields, the one or more fields including a medical events field, the medical record function comprising a medical events function adapted to receive, as input, one or more medical events, to analyze the one or more medical events to determine an order of the medical events according to at least one predetermined criterium, and to display in the medical events field a listing of the one or more medical events in the determined order; and
at least one other patient information function operable to receive and process patient information and display the processed patient information in at least one of the one or more fields of the medical record, the at least one other patient information function adapted to share information with the medical record function and to automatically process information received from the medical record function.

18. A medical practice management system, comprising:
at least one processor;
at least one input device coupled to the at least one processor for inputting information to the at least one processor;
at least one output device coupled to the at least one processor for outputting information from the at least one processor; and
at least one application executable by the at least one processor, the application comprising a completed visit module and a patient information module;
wherein the completed visit module is operable to:
receive medical visit information associated with a patient's medical office visit;
display the received medical visit information using the at least one output devices; and
communicate the medical visit information to the patient information module; and
wherein the patient information module is operable to:
receive as input from the at least one input device a plurality of medical events associated with the patient;
determine an order of the plurality of medical events according to at least one predetermined criterium;
generate a medical record associated with the patient, the medical record comprising a medical events field displaying a listing of at least a portion of the plurality of medical events in the determined order;
receive the medical visit information from the completed visit module, the medical visit information comprising one or more additional medical events;
determine an updated order of the medical events, including the additional medical events associated with the medical visit information, according to the at least one predetermined criterium; and
updating the medical record, including updating the listing of medical events displayed in the medical events field according to the determined updated order of the medical events.

19. The medical practice management system of claim 18, wherein the patient information module is operable to generate, using at least one of the output devices, a printed version of the medical record that may be inserted into the patient's wallet.

20. The medical practice management system of claim 19, wherein the printed version of the medical record is approximately credit-card sized.

21. The medical practice management system of claim 19, wherein the number of medical events displayed in the medical events field of the printed version of the medical record is limited to a particular number based on the size of the printed version of the medical record.

22. A medical practice management system, comprising:
at least one processor;
at least one input device coupled to the at least one processor for inputting information to the at least one processor;
at least one output device coupled to the at least one processor for outputting information from the at least one processor; and
at least one application executable by the at least one processor, the application comprising a laboratory reports module and a patient information module;
wherein the laboratory reports module is operable to:
receive a plurality of laboratory test results associated with a patient;
provide access to the laboratory test results in order to analyze the laboratory test results;
for each of the laboratory test results, receive as input from the at least one input device an interpretation of that laboratory test result; and
communicate at least a portion of the laboratory test results associated with the patient to the patient information module; and
wherein the patient information module is operable to:
receive the laboratory test results from the laboratory reports module; and
generate a printed version of a medical record associated with the patient, the printed version of the medical record comprising one or more fields displaying a listing of at least a portion of the laboratory test results.

23. The medical practice management system of claim 22, wherein the interpretation of each laboratory test result comprises an assessment, a recommendation, and a follow-up recommendation for that laboratory test result.

24. The medical practice management system of claim 22, wherein:
the laboratory reports module is operable to communicate the interpretations of one or more of the laboratory test results to the patient information module; and
the patient information module is operable to display at least one of the interpretations of the laboratory test results in at least one of the fields in the printed version of the medical record.

25. The medical practice management system of claim 22, wherein the printed version of the medical record is sized such that it may be inserted into the patient's wallet.

26. The medical practice management system of claim 25, wherein the printed version of the medical record is approximately credit-card sized.
